(19) United States
(12) Patent Application Publication
(10) Pub. No.: US 2015/0074045 A1
(43) Pub. Date: Mar. 12, 2015

(54) Business Rule Management System

(71) Applicant: INTERNATIONAL BUSINESS MACHINES CORPORATION, Armonk, NY (US)

(72) Inventors: Sandra E. Belfils, Juan les Pins (FR); Stephane Hillion, Valbonne (FR); Thierry Kormann, Valbonne (FR); Cyril Mathey, Issy les Moulineaux (FR)

(21) Appl. No.: 14/481,392

(22) Filed: Sep. 9, 2014

(30) Foreign Application Priority Data
Sep. 9, 2013 (GB) 1315971.0

(51) Int. Cl. G06F 17/30

(52) U.S. Cl. CPC G06F 17/30115
USPC 707/609; 707/821; 707/687

(57) ABSTRACT

Mechanisms for operating a business rule management system are provided. The mechanisms access a text file describing one or more business processes, and bindings of a plurality of text chunks within the text file to a respective plurality of elements within the business rule management system. The mechanisms detect a change in a bound text chunk in the text file and modify the respective bound element within the business rule management system according to the detected change in the bound text chunk in the text file.

### BACKGROUND

This invention relates to a method of, and computer program product for, operating a business rule management system and to the business rule management system itself. In one illustrative embodiment, the invention provides a system, computer program product, and method for editing and managing formal business rules through business specification documents.

Within the business world, word processors are extremely useful tools and have a large variety of uses and applications. Many single users, offices, businesses, and organizations use computers and word processors to compose, edit, format and print written documents describing business rules with high quality, in a timely fashion. Business rules are abstractions of the policies and practices of a business organization. Business rules also represent a natural step in the application of computer technology aimed at enhancing productivity in the workplace. In a computer system, business rules can be expressed in either conventional programming languages or natural languages. Programs designed to execute business rules are called rule engines.

Breaking down the barriers between the stakeholders who write documents by using a word processor, and software developers who develop the corresponding application, remains a real challenge. One existing approach is a two-step process that consists of taking advantage of a business analyst or consultant to first interpret a document written by a business person, and then assist the IT organization implementing the business rules as described in the document. The major drawback with this approach is that document and software remain completely independent. Determining correlations between what is in the document and what the rules do is complicated.

A second approach available in business rule management systems is to ask a business person to describe business rules using a controlled natural language (CNLs) instead of natural language. CNLs are subset of natural languages, obtained by restricting both the grammar and the vocabulary in order to reduce or remove ambiguity and complexity. This approach has three important weaknesses. Firstly, prior to being able to write business rules, a business analyst needs to create a vocabulary and a grammar for the business domain. Secondly, continued updates of business rules often require vocabulary and/or language modifications, something not possible by a business user. Finally, decomposing business policies in logical constructs (or merely describing logical constructs using a CNL) is difficult to achieve.

Assuming business rules have been written down in a computer system, a third possible approach consists of creating (or generating) a dedicated user interface such that business users can perform changes directly to the rules. On the one hand, this solution provides a positive user experience for business users who can then directly change the business rules. On the other hand, major business updates within an organization will still be written down in a document first. Again, the document and the software remain completely independent.

Finally, when organizations need to deploy, execute, monitor, or maintain business rules, they often rely on a business rule management system. Most business rule management system vendors provide tools, allowing both technical developers and business analysts to manage business rules. Even though a business rule management system provides business-usable tools, such an approach requires vendor specific products expertise.

### SUMMARY

According to a first aspect of the illustrative embodiments, there is provided a method of operating a business rule management system, the method comprising accessing a text file describing one or more business processes, accessing bindings of a plurality of text chunks within the text file to a respective plurality of elements within the business rule management system, detecting a change in a bound text chunk in the text file, and modifying the respective bound element within the business rule management system according to the detected change in the bound text chunk in the text file.

According to a second aspect of the illustrative embodiments, there is provided a business rule management system comprising a binding engine arranged to access a text file describing one or more business processes, access bindings of a plurality of text chunks within the text file to a respective plurality of elements within the business rule management system, detect a change in a bound text chunk in the text file, and modify the respective bound element within the business rule management system according to the detected change in the bound text chunk in the text file.

According to a third aspect of the illustrative embodiments, there is provided a computer program product on a computer readable medium for operating a business rule management system, the product comprising instructions for accessing a text file describing one or more business processes, accessing bindings of a plurality of text chunks within the text file to a respective plurality of elements within the business rule management system, detecting a change in a bound text chunk in the text file, and modifying the respective bound element within the business rule management system according to the detected change in the bound text chunk in the text file.

Owing to the illustrative embodiments, it is possible to provide a method, and system for binding (or connecting) portions of a document expressed in natural language to elements of a business rule management system, such as business rules executed by a rule engine. The illustrative embodiments take advantage of a binding engine to create, resolve, and manage links between text chunks of a digital document and their implementation counterparts in, for example, a set of business rules, or in any piece of data used within a business rule management system. Embodiments of the present invention relate to business rule management, and more specifically to user interface for defining, editing, and managing business rules in a business rule management system. In addition to performing textual substitution to create an updated version of specific rules, the binding engine can perform multiple tasks in response to a document change. For instance, a binding engine can deploy a new version of the rules to a rule engine, or communicate with other business rule management system modules such as a decision validation service that tests and simulates the impact of business rule changes.

This illustrative embodiments provide several advantages over existing systems. The improved system is business user friendly, since it allows business users to keep using a document, and a word processor for creating, and changing business rules. The system is natural and productive, as it does not require defining a vocabulary or using a CNL, as mentioned above. Business users can keep using natural language for both defining and updating rules. The system also greatly reduces the initial effort of rule harvesting. The system further provides excellent traceability since the document being the primary user interface for business users, any change made can immediately trigger an update to the application and/or to the rule engine.

In one illustrative embodiment, the method further comprises, after detecting a change in a bound text chunk in the text file, validating the change, prior to modifying the respective bound element within the business rule management system according to the detected change in the bound text chunk in the text file. Although changes in the text file are intended to be fed through directly to the relevant part of the business rule management system, validation of the change to a bound text chunk increases the likelihood of errors being caught before they are implemented. The validation process will depend on the nature of the text chunk that is bound to an element in the business rule management system. For example, if the text chunk is a simple figure such as “$200” representing a discount to a certain type of customer, then a change to “ [symbol] 250” would be caught by the validation process as the currency symbol has been changed, probably in error.

Advantageously, the elements within the business rule management system comprise a plurality of rules, and the operation of modifying the respective bound element within the business rule management system according to the detected change in the bound text chunk in the text file comprises modifying a rule. As mentioned in detail above, the principal use of the improved system is to allow business users to update rules within a business rule management system by amending a text file, without having to have any contact with a business rule management system or understand the generation and syntax of the business rules.

The illustrative embodiments may further comprise triggering a specific action in response to modifying the respective bound element within the business rule management system according to the detected change in the bound text chunk in the text file. The business rule management system can be configured to perform one or more actions in response to the changes made to elements within the business rule management system. This could include such actions as sending electronic communication, compiling and sending reports, running test suites etc. All of these can be triggered automatically to ensure that the business rule management system, for example, is able to identify that any changes made do not have any unintended negative consequences.

The illustrative embodiments may further comprise receiving a defined user input and providing access to the bound plurality of text chunks within the text file. The business rule management system can be arranged to provide continuous access to the bindings, in order to allow a suitably qualified administrator to access and review the bindings between text chunks of the text file and the rules (or other elements) of the business rule management system. This provides a level of supervision that ensures that the bindings can be reviewed as and when needed.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is a schematic diagram of a business rule management system;

FIG. 2 is a screenshot of a portion of a text file;

FIG. 3 is an example of a rule of the business rule management system;

FIG. 4 is a flowchart of a method of maintaining the business rule management system;

FIG. 5 is a further schematic diagram of the business rule management system; and

FIG. 6 is a further flowchart of a method of maintaining the business rule management system.

### DETAILED DESCRIPTION

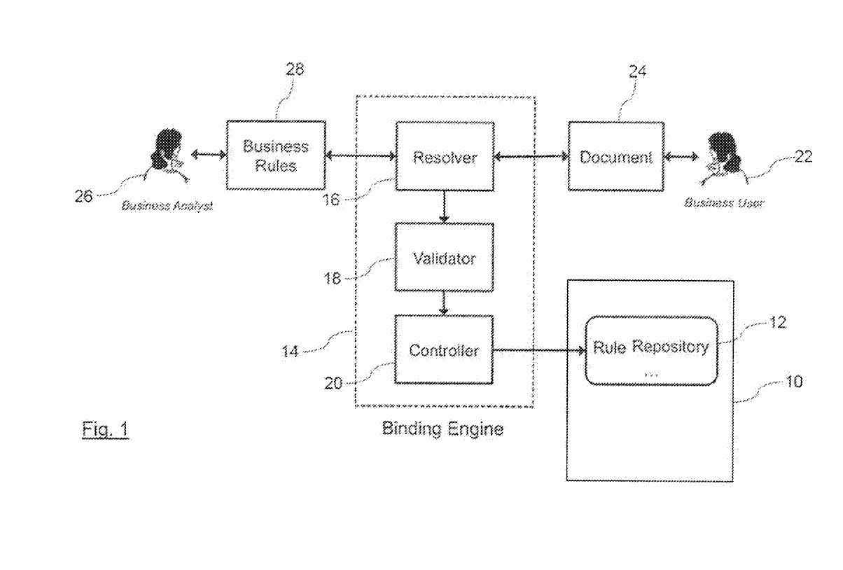

FIG. 1 shows a business rule management system 10, which includes a rule repository 12. Connected to the business rule management system 10 is a binding engine 14, which has three principal functional components, a resolver 16, a validator 18 and a controller 20. A business user 22 has access to a text file 24, which is accessible by the resolver 16 of the binding engine 14. A business analyst 26 composes business rules 28, which are also accessible by the resolver 16 of the binding engine 14. Although the binding engine 14 is shown as being external to the business rule management system 10 in this embodiment, it could equally be realized as an internal component of the business rule management system 10.

The binding engine 14 can be implemented purely as a dedicated hardware component or can be implemented as a software component being executed on suitable hardware, such as a network-connected server, which can also run the business rule management system 10. If the binding engine 14 is a software component, then it can comprise a computer program product on a computer readable medium such as a CD-ROM, which is loaded into the hardware when the binding engine is initiated. The computer program product comprises a set of instructions that define the operation of the binding engine 14. The installed computer program product, when executed, controls the interaction of the binding engine 14 with the other components.

The text file 24 describes one or more business processes that are implemented by the business rule management system 10. The system shown in FIG. 1 is designed so that the business user 22 can make changes to the text file 24 and these changes will be implemented correctly in the business rule management system 10 by the binding engine 14, without the need for the business user to work directly with the business rule management system 10. The example of FIG. 1 is explained in the context of business rules 28 that are embodied in the business rule management system 10, but other parts of the business rule management system 10, such as actions and test suites can also be embodied in the text file 24.

When the text file 24 was originally created by the business user 22, the business analyst 26 was responsible for creating the business rules 28 that embody the business processes of that document 24. For example, the text file 24 may specify pricing and discount information for different regions for different order sizes of different products. The business analyst 26 will turn these plain text statements (or table etc.) into business rules 28 that can be understood by the business rule management system 10, and will bind the relevant text chunks in the text file 24 to the correct business rules 28, which is stored by the binding engine 14.

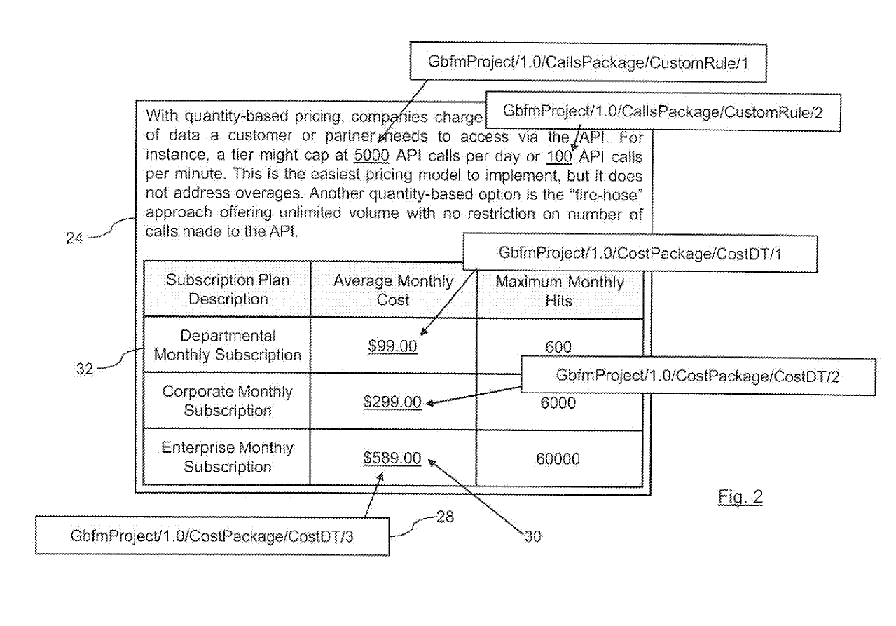

FIG. 2 shows an example of a portion of a text file 24, as the business user 22 would see on a display device of a standard personal computer, for example. The text file 24 is accessed via a suitable word processing application, which in this case supports extended functions such as charts and tables, although this is not material, as a plain text only file would be sufficient. Various text chunks 30 are underlined within the document 24, each of which is bound to a respective rule 28. The view shown in FIG. 2 is to illustrate the invention; the user would not actually see the rules 28 on the display device.

When the text file 24 was first created by the business user 22, as a standard text file 24, then the business analyst 26 would take that text file 24 and generate the associated rules 28, using their experience and skills as a business analyst to do so. In addition, the business analyst 26 would create the bindings between the various text chunks 30 and the respective rules 28; thereby linking specific parts of the text file 24 to specific rules 28. The binding engine 14 stores these links, or is arranged to have access to the links, which are saved in a suitable format. Therefore, in relation to the text file 24, the binding engine 14 is aware of the bindings from the text file 24 to the rules 28.

In the text file 24, as shown in the screenshot of FIG. 2, a table 32 is shown that has a column entitled “Average Monthly Cost”, which is populated with various values. The values in this column are underlined, to indicate that they have been bound to specific rules 28. The underlining shown here is to illustrate the invention, the user of the text file 24 will not necessarily be able to see the underlining. The various chunks 30 are linked to specific business rules 28 and any change that is made to the values in the column of the table 32 will result in one or more changes to the linked rules 28.

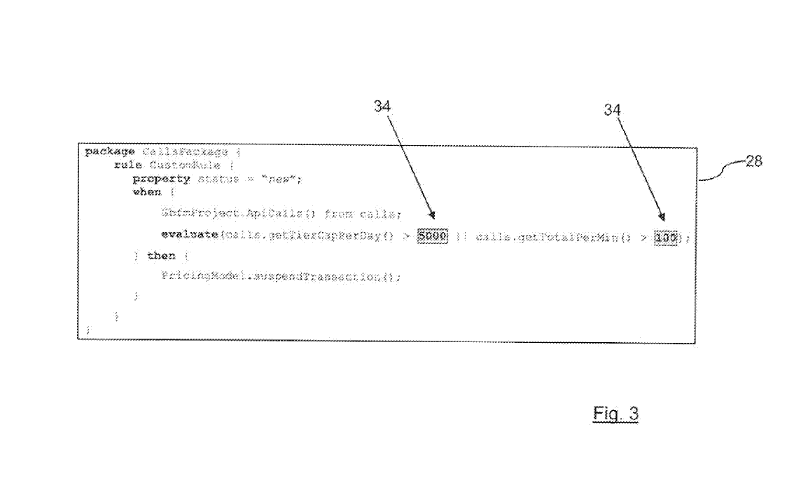

FIG. 3 shows an example of an individual rule 28 that will be stored in the rule repository 12, which forms part of the business rule management system 10. The rule 28 has been generated by the business analyst 26, who is a business specialist who is familiar with the business rule management system 10. The format and structure of the business rule 28 will depend upon the specifics of the grammar used by the business rule management system 10 and is not material to the system being described here. The rule 28 will be one of many rules 28 that have been generated by the business analyst 26 from the original text document 24 created by the business user 22.

The rule 28 encapsulates a part of the plain text within the text document 24. In the example of FIG. 3, the rule 28 relates to a call package (for example for a business mobile phone user) and sets parameters for usage and charging. Within the rule 28 are two specific components 34 that are highlighted. The two components 34 are numeric values that the business analyst 26 has taken from the text document 24 and imported into the rule 28. At the same time, the text chunks 30 within the text file 24 that contained the numeric values are bound to the rule 28 and specifically the highlighted components 34 within the rule 28.

The bindings are known to the binding engine 14, which stores or has access to the bindings between the text file 24 and the rule 28, which are essentially independent of each other in all other regards. The business user 22 can continue to access the text file 24, without necessarily being aware of the bindings between text chunks 30 of the text file 24 and elements (here rules 28) of the business rule management system 10. Similarly, the business rule management system 10 will operate with the rules 28, without needing to have any regard to the bindings that link text chunks 30 to components within the rules 28.

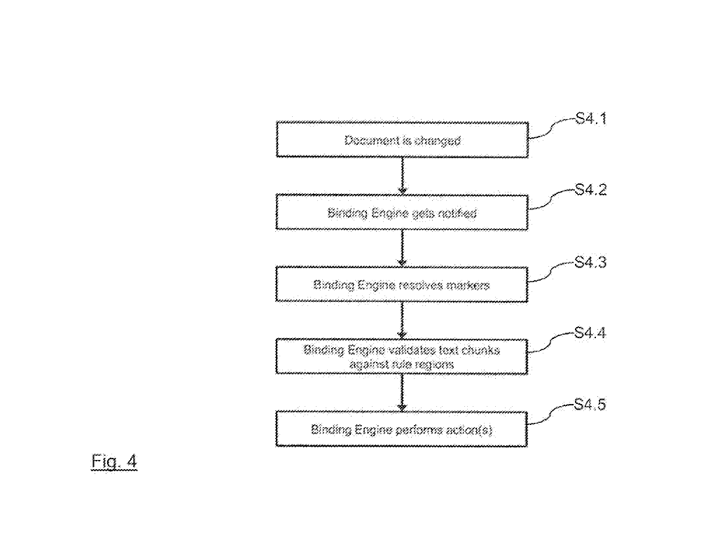

FIG. 4 illustrates the process that takes place once the business user 22 makes an amendment to the text file 24. The business user 22 can access the text file 24 through a normal word processing application on their desktop computer and can change the contents of the text file 24. For example, a business decision may have been made to change the pricing structure of the call package represented in the rule 28 shown in FIG. 3. The business user 22 is able to access and change the document 24 without having to have any knowledge of the business rule management system 10 or of the binding engine 14.

Once the document 24 has been changed, in step S4.1 of FIG. 4, then the binding engine 14 is notified of the change, in step S4.2. The binding engine 14 detects a change in one or more bound text chunks 30 of the text file 24. In steps S4.3 and S4.4, the binding engine 14 resolves the markers denoting the links between the text chunks 30 and the rules 28 and validates the changes. Once the binding engine 14 has identified a change to a text chunk 30 that is linked to a rule 28, then the binding engine 14 will validate that change against a predefined schema. For example, if text chunk 30 is a numeric value, then the schema may define upper and lower bounds for the numeric value.

Once the change has been validated, then at step S4.5, the binding engine 14 will modify the rule 28 that is linked to the text chunk 30 that has been changed, according to the nature of the change. So if the business user 22 changes a numeric value from $200 to $220, for example, then this change will be carried over into the rule 28 that is linked to this specific text chunk 30, as defined by the bindings between the text file 24 and the rule 28. Although this example refers to a rule 28 within the business rule management system 10, other elements of the business rule management system 10 could be bound to text chunks 30, not just rules 28.

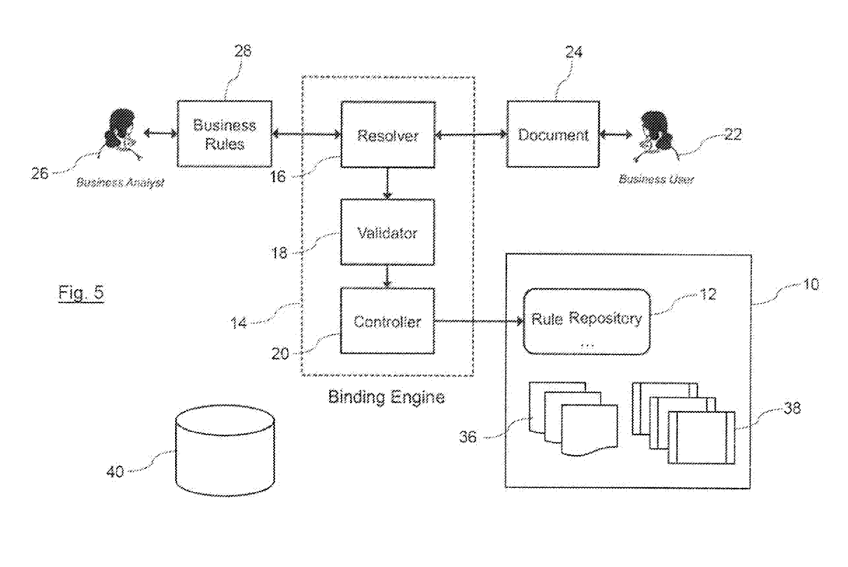

FIG. 5 shows a schematic view of the business rule management system 10 showing additional elements of the business rule management system 10. In addition to the rules 28 stored in the rule repository 12, the business rule management system 10 also comprises test suites 36 and specific actions 38. The rules 28, test suites 36 and actions 38 are all elements of the business rule management system 10. The text file 24 can have text chunks 30 bound to any of these different elements within the business rule management system 10, binding specifically to components within the individual elements. The binding engine 14 stores, or has access to, the bindings 40 between the text file 24 and the elements of the business rule management system 10.

For example, the business user 22 may include within the text file 24 details of a notification that needs to be made to a named individual (for example in the form of an email) in certain business circumstances. This may then be codified as an action 38 within the business rule management system 10 and the business analyst 26 will ensure that the specific action 38 is bound correctly to the text chunk 30 within the text file 24 that relates to this particular notification. As detailed above, neither the text file 24 nor the actual action 38 need be altered in any way, the binding 40 is stored that contains the detail of the link between the notification and the action 38.

Should the text file 24 be changed in the future in relation to this notification, for example to change the person notified or add in an additional person to the notification, then business user 22 can go ahead and make that change without needing to consider the effect on the business rule management system 10, since the binding engine 14 will resolve, validate and update the business rule management system 10 accordingly. The relevant binding 40 will cause the binding engine 14 to detect the change and this will be validated according to the appropriate schema (which might require the notification to be to a functioning email address, for example). Once validated, the action 38 is triggered accordingly.

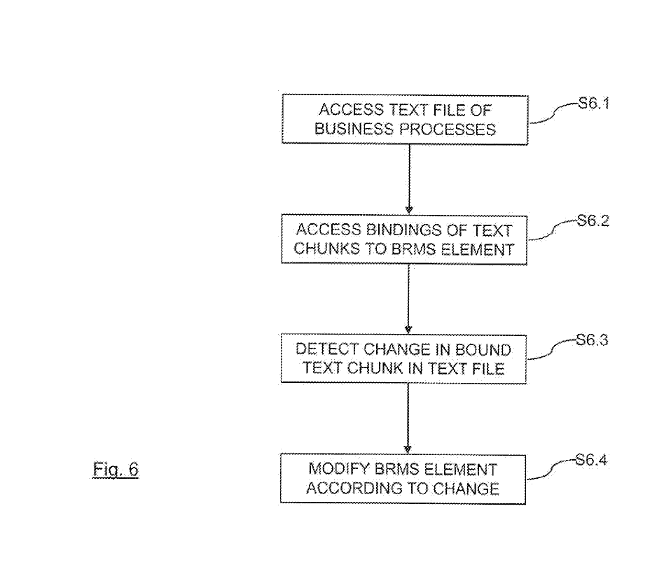

FIG. 6 summarizes the method of operating the business rule management system 10 at the most general level, regardless of whether the element being changed within the business rule management system 10 is a rule 28 or a different element. The method comprises, firstly step S6.1, accessing the text file 24, which describes one or more business processes. The second step in the method, step S6.2, comprises accessing bindings 40 of a plurality of text chunks 30 within the text file 24 to a respective plurality of elements within the business rule management system 10. In this way, the binding engine 14 has access to the text file 24 and the links 40 between the chunks 30 of the text file and the connected elements.

The next step in the method is S6.3, which comprises detecting a change in a bound text chunk 30 in the text file 24. The business user 22 (or indeed anyone with access to the text file 24) can make changes to the document 24, for example when organizational or financial changes are made to one or more of the business processes that are detailed in the text file 24. The binding engine 14 detects these changes, either directly by monitoring the text file 24 or through the receipt of a suitable notification. These changes are resolved and validated, to ensure that the nature of the change is within predefined boundaries for acceptable changes.

The final step in the method is step S6.4, which comprises modifying the respective bound element (rule, test suite, action etc.) within the business rule management system 10 according to the detected change in the bound text chunk 30 in the text file 24. The business user's change to the text file 24 is populated through to the correct element within the business rule management system 10 by the binding engine 14, which identifies where in the correct element of business rule management system 10 the change needs to be made and updates that element accordingly. Multiple changes to the text file 24 are all handled by the binding engine 14 at the same time, and the business rule management system 10 is updated to reflect the user's changes.

1. A method, in a computing device implementing a binding engine, for updating elements of a business rule management system, the method comprising:
accessing, by the binding engine, a text file describing one or more business processes,
generating, by the binding engine, bindings of a plurality of text chunks within the text file to respective elements of a plurality of elements within the business rule management system,
detecting, by the binding engine, a change in a text chunk, in the text file, bound to an element of the plurality of elements, and
modifying, by the binding, an element bound to the changed text chunk within the business rule management system, according to the detected change in the changed text chunk, wherein an operation of the business rule management system is changed according to the modification to the element bound to the changed text chunk.

2. A method according to claim 1, further comprising, after detecting the change in the text chunk in the text file, validating the change, prior to modifying the element bound to the changed text chunk, within the business rule management system according to the detected change in the text chunk.

3. A method according to claim 1, wherein the elements within the business rule management system comprise a plurality of rules and, wherein modifying the element bound to the changed text chunk, within the business rule management system according to the detected change in the bound text chunk in the text file, comprises modifying a rule bound to the changed text chunk.

4. A method according to claim 1, further comprising triggering a specific action defined by the element bound to the changed text chunk, in response to modifying the element bound to the changed text chunk within the business rule management system according to the detected change in the text chunk.

5. A method according to claim 1, further comprising receiving a defined user input and providing access to the plurality of text chunks within the text file in response to the defined user input.

6. A business rule management system comprising a binding engine configured to:
access a text the describing one or more business processes,
generate bindings of a plurality of text chunks within the text file to respective elements of a plurality of elements within the business rule management system,
detect a change in a text chunk, in the text file, bound to an element of the plurality of elements, and
modify an element bound to the changed text chunk within the business rule management system, according to the detected change in the changed text chunk, wherein an operation of the business rule management system is changed according to the modification to the element bound to the changed text chunk.

7. A system according to claim 6, wherein the binding engine is further configured to, after detecting the change in the text chunk in the text file, validate the change, prior to modifying the element bound to the changed text chunk, within the business rule management system according to the detected change in the text chunk.

8. A system according to claim 6, wherein the elements within the business rule management system comprise a plurality of rules and the binding engine is configured to, when modifying the element bound to the changed text chunk, within the business rule management system according to the detected change in the bound text chunk in the text file, modify a rule bound to the changed text chunk.

9. A system according to claim 6, wherein the binding engine is further configured to trigger a specific action defined by the element bound to the changed text chunk, in response to modifying the element bound to the changed text chunk within the business rule management system according to the detected change in the text chunk.

10. A system according to claim 6, wherein the binding engine is further configured to receive a defined user input and provide access to the plurality of text chunks within the text file in response to the defined user input.

11. A computer program product on a non-transitory computer readable medium for operating a business rule management system, the product comprising instructions, which when executed by a computing device, cause the computing device to:
access a text file describing one or more business processes,
generate bindings of a plurality of text chunks within the text file to respective elements of a plurality of elements within the business rule management system,
detect a change in a text chunk, in the text file, bound to an element of the plurality of elements, and
modify an element bound to the changed text chunk within the business rule management system, according to the detected change in the changed text chunk, wherein an operation of the business rule management system is changed according to the modification to the element bound to the changed text chunk.

12. A computer program product according to claim 11, wherein the computer program product further comprises instructions that cause the computing device to, after detecting the change in the text chunk in the text file, validate the change, prior to modifying the element bound to the changed text chunk, within the business rule management system according to the detected change in the text chunk.

13. A computer program product according to claim 11, wherein the elements within the business rule management system comprise a plurality of rules and modifying the element bound to the changed text chunk, within the business rule management system according to the detected change in the bound text chunk in the text file comprises modifying a rule bound to the changed text chunk.

14. A computer program product according to claim 11, wherein the computer program product further comprises instructions that cause the computing device to trigger a specific action defined by the element bound to the changed text chunk, in response to modifying the element bound to the changed text chunk within the business rule management system according to the detected change in the text chunk.

15. A computer program product according to claim 11, wherein the computer program product further comprises instructions that cause the computing device to receive a defined user input and provide access to the plurality of text chunks within the text file in response to the defined user input.

16. A method according to claim 1, wherein:
the plurality of elements within the business rule management system are business rules managed by the business rule management system,
generating bindings of a plurality of text chunks within the text file to respective elements of a plurality of elements within the business rule management system comprises binding a numerical value specified in a text chunk of the text file to a numerical parameter of a business rule bound to the text chunk,
detecting a change in a text chunk in the text file bound to an element of the plurality of elements comprises detecting a change in a numerical value of the changed text chunk, and
modifying the element bound to the changed text chunk comprises updating a numerical parameter of the business rule bound to the changed text chunk based on the change to the numerical value in the changed text chunk.

17. The method according to claim 1, wherein modifying the element bound to the changed text chunk is performed automatically without a human user, that submitted the change in the text chunk, being made aware of the modification to the element bound to the changed text chunk.

18. A system according to claim 6, wherein:
the plurality of elements within the business rule management system are business rules managed by the business rule management system,
generating bindings of a plurality of text chunks within the text file to respective elements of a plurality of elements within the business rule management system comprises binding a numerical value specified in a text chunk of the text file to a numerical parameter of a business rule bound to the text chunk,
detecting a change in a text chunk in the text file bound to an element of the plurality of elements comprises detecting a change in a numerical value of the changed text chunk, and
modifying the element bound to the changed text chunk comprises updating a numerical parameter of the business rule bound to the changed text chunk based on the change to the numerical value in the changed text chunk.

19. A system according to claim 6, wherein modifying the element bound to the changed text chunk is performed automatically without a human user, that submitted the change in the text chunk, being made aware of the modification to the element bound to the changed text chunk.

20. A computer program product according to claim 11, wherein:
the plurality of elements within the business rule management system are business rules managed by the business rule management system,
generating bindings of a plurality of text chunks within the text file to respective elements of a plurality of elements within the business rule management system comprises binding a numerical value specified in a text chunk of the text file to a numerical parameter of a business rule bound to the text chunk,
detecting a change in a text chunk in the text file bound to an element of the plurality of elements comprises detecting a change in a numerical value of the changed text chunk, and
modifying the element bound to the changed text chunk comprises updating a numerical parameter of the business rule bound to the changed text chunk based on the change to the numerical value in the changed text chunk.
